(19) United States
(12) Patent Application Publication
(10) Pub. No.: US 2014/0083416 A1
(43) Pub. Date: Mar. 27, 2014

(54) PROCESS FOR PREPARING MICRO- AND NANOCRYSTALLINE CELLULOSE

(71) Applicants: Markus Nuopponen, Helsinki (FI); Anne Meriluoto, Espoo (FI); Eero Kontturi, Helsinki (FI)

(72) Inventors: Markus Nuopponen, Helsinki (FI); Anne Meriluoto, Espoo (FI); Eero Kontturi, Helsinki (FI)

(73) Assignee: UPM-KYMMENE CORPORATION, Helsinki (FI)

(21) Appl. No.: 14/006,477

(22) PCT Filed: Mar. 21, 2012
(86) PCT No.: PCT/FI12/50269

§ 371 Date: Dec. 2, 2013

(30) Foreign Application Priority Data
Mar. 21, 2011 (FI) 20115274

(51) Int. Cl. C08B 15/00

(52) U.S. Cl. CPC C08B 15/00
USPC 127/29; 127/37

(57) ABSTRACT

The invention relates to a process for preparing micro- and nanocrystailine cellulose material in the presence of an acid. More specifically, the invention relates to a process, in which the cellulose material is hydrolyzed in the presence of an acid in the gas phase while the moisture content of cellulose is between 1% and 80%, the cellulose material is surface-modified, and mech anically treated in order to obtain micro- and/or nanocrystailine cellulose material. The invention also relates to a cellulose product prepared by the said process and the use thereof in food and liquid crystal applications as well as in optical, cosmetic and medical applications.

### FIELD OF THE INVENTION

The invention relates to a process for preparing micro- and/or nanocrystalline cellulose material in the presence of an acid in the gas phase. The invention also relates to a cellulose product prepared by the said process, as well as the use thereof.

### BACKGROUND OF THE INVENTION

In plant cell walls cellulose is organized into microfibrils, in which most of the cellulose is in crystalline form. The microfibrils also contain less-organized or amorphous parts. The amorphous parts can be removed by a chemical reaction, i.e. selective acid hydrolysis, after which only the crystalline parts of the cellulose remain. The result is either microcrystalline or nanocrystalline cellulose, depending on the conditions. Both are actively used in modern material science applications.

Due to the effect of the acid, the cellulose is hydrolyzed, meaning that it breaks at the glycosidic oxygen bridge, and at the same time one water molecule becomes attached to it. Cellulose hydrolysis therefore requires the presence of a water molecule. Organic or inorganic acids can be used in cellulose hydrolysis. In acid hydrolysis processes, high temperatures (between about 100° C. and about 200° C.) or large acid concentrations, for example, 65% H₂SO₄ (aq), have been used in the manufacture of nanocrystals.

Dong et al. 1998 (Dong et al., Effect of microcrystalline preparation conditions on the formation of colloid crystals of cellulose. Cellulose 5:19-32, 1998) discloses the manufacture of nanocrystalline cellulose by using liquid acid.

Patent publication RU 2281993 discloses a process for preparing microcrystalline cellulose by using gaseous hydrochloric acid (HCl). The HCl gas is prepared separately by a reaction between concentrated liquid HCl and calcium chloride, after which the released gaseous hydrochloric acid is mixed with air and the mixture is transferred onto the cellulose substrate that is to be hydrolyzed.

Patent publications EP 0248252 and FI 872378 disclose a process for preparing microcrystalline cellulose.

Higgins et al. 1982 (Higgins and Ho, Hydrolysis of cellulose using hydrogen chloride: a comparison between liquid phase and gaseous phase processes. Agricultural Wastes 4(2):97-116, 1982) discloses the hydrolyzation of cellulose obtained from newsprint, paperboard, and wheat straws by using both liquid 41.7% hydrochloric acid and gaseous hydrochloric acid.

Patent publication WO 1996/025553 discloses a method and equipment for hydrolyzing lignocellulose material under pressurized conditions at a temperature between 160° C. and 230° C.

U.S. Pat. No. 5,123,962 discloses fine suspensions of cellulose, which have been pre-treated.

However, the above-presented prior art processes entail problems. In the known processes, the manufacture of nano- and microcrystalline cellulose requires high acid concentrations, heating and large amounts of water for the rinsing performed after the hydrolysis. Efficient and fast cellulose hydrolysis has required high acid concentration. Furthermore, the use of liquid acid and its handling is difficult in high concentrations. The dialysis used for purification is difficult to perform on industrial scale, and considerable amounts of waste water are formed. In addition, when using hydrochloric acid or nitric acid in the hydrolysis, the problem is that the surface of the cellulose crystal remains neutral. The inherent tendency of cellulose to aggregate prevents, in this case, the dispersion of micro- or nanocrystals created by hydrolysis, for example, in water, and separate dispersing agents are needed in order to achieve the dispersion of the crystals in water.

### BRIEF DESCRIPTION OF THE INVENTION

The object of the invention is to solve the above-mentioned problems. More specifically, the object of the invention is to provide a process for chemically modifying cellulose material, by means of which the micro- or nanocrystalline cellulose material can be dispersed without separate dispersing agents.

The object of the invention is reached by a process for preparing micro- and/or nanocrystalline cellulose material in the presence of an acid in the gas phase, the process comprising steps, in which the cellulose material is hydrolyzed in the presence of at least one acid in the gas phase, the moisture content of the cellulose being between 1% and 80%, and the hydrolyzed cellulose material is mechanically treated in order to obtain micro- and/or nanocrystalline cellulose material.

The surface of the micro- and nanocrystals is modified, so that the crystals would form a homogeneous dispersion in water. As a result of the acid hydrolysis of chemically modified masses, nanocrystals to be dispersed in water can be obtained. New functional groups can be introduced through chemical reactions onto the surface of micro- and nanocrystals either by pre- and/or post-treatments. In other words, the cellulose material can be modified before and/or after the hydrolysis. A good dispersion of nanocrystals in aqueous solution requires electrostatic repulsion between the individual cellulose nanocrystals. In order to use nanocrystals, for example, in hydrophobic composites to impart strength, the surface of the nanocrystals is modified to provide hydrophobicity.

In the inventive process an acid can be used having such a vapour pressure that it gasifies into the gas phase and adsorbs onto the cellulose surface at room temperature. For example, one of the following acids can be used: hydrochloric acid (HCl), nitric acid (HNO₃) and/or trifluoroacetic acid. The concentration of the acid used can be at least 1% by volume.

In the inventive process the hydrolyzed cellulose can be dispersed in water or in a suitable solvent, such as formic acid or ethyl acetate. Hydrolyzed cellulose can be mechanically broken down, which can comprise for example mechanical stirring and/or ultrasound treatment.

A further object of the invention is a product that contains micro- and/or nanocrystalline cellulose material. The invention also relates to a cellulose product prepared by the said process of the invention and the use thereof in food applications and in optical, cosmetic and medical applications.

By using an acid: in the gas phase, it is possible to avoid several of the environmentally harmful micro- and nanocrystalline cellulose material manufacturing steps, which may also be difficult to apply on industrial scale. During the hydrolysis in the gas phase and the surface modification of cellulose, the amount of water used is as small as possible. Thus, in the inventive process large amounts of water are not needed for rinsing the sample, recycling of the acid is easier and dialysis used for purification can be omitted. Therefore the recycling of the material and its processability are improved. In addition, hydrolysis speed is relatively high at room temperature and normal atmospheric pressure. A gaseous acid, such as hydrochloric acid or nitric acid, breaks the cellulose down into micro- and/or nanocrystals. The hydrolysis speed of hydrochloric acid is higher than that of nitric acid due to a greater gas pressure.

A preferred embodiment of the disclosed invention is described in the following detailed description of the invention.

### BRIEF DESCRIPTION OF THE DRAWINGS

In the following, some preferred embodiments of the invention are presented in more detail by referring to the attached figures, in which

FIG. 1 shows an experimental arrangement for hydrolyzing cellulose in the presence of gaseous hydrochloric acid (HCl). Liquid HCl is placed on the bottom of the desiccator. The cellulose material, here a filter paper made of cotton, is hydrolyzed in the desiccator in the presence of gaseous hydrochloric acid.

FIG. 2 demonstrates the breakdown rates with different hydrochloric acid concentrations, showing the time, in which the LODP (LODP=level-off degree of polymerization) was reached.

FIG. 3 shows the change of cellulose's degree of polymerization (DP) as a function of time with different hydrochloric acid concentrations.

FIG. 4A shows the development of cellulose's degree of polymerization (DP) in a sample of cotton cellulose (Whatman 1 filter paper) in the presence of gaseous HCl.

FIG. 4B shows an atomic force microscopy (AFM) 5×5 μm² image of cellulose nanocrystals made from the filter paper hydrolyzed with HCl gas and dispersed in formic acid.

FIG. 5 shows the development of cellulose's degree of polymerization (DP) in a sample of cotton cellulose (Whatman 1 filter paper) in the presence of gaseous HNO₃. The acid concentrations of the liquid phase are 7.7 and 15.4 mol/l.

FIG. 6 shows the adding of sulphate groups onto the surface of cellulose (55% H₂SO₄, 60° C., 2 h), when the substrate (filter paper) is first (A) hydrolyzed for 3 hours with 35% HCl vapour or (B) left untreated.

FIG. 7 shows AMF images of a cotton fibre hydrolyzed with HCl and dispersed in formic acid (A) 5×5 μm² and (B) 2×2 μm².

FIG. 8 shows AMF images of a cotton fibre hydrolyzed with HNO₃ and dispersed in formic acid (A) 5×5 μm² and (B) 2×2 μm².

FIG. 9 shows a transmission electron microscopy (TEM) image indicating that in formic acid is made to disperse nanocrystals prepared with acid vapour and having the same length (7 nm) as when prepared with liquid acid.

FIG. 10 shows an AMF image of a cotton fibre hydrolyzed with HNO₃ and dispersed in ethyl acetate.

### DETAILED DESCRIPTION OF THE INVENTION

In the following, the invention is described in more detail referring to the exemplary preferred embodiments and the drawings.

The invention relates to a process for preparing micro- and nanocrystalline cellulose material in the presence of an acid in the gas phase. The invention also relates to a cellulose product prepared by said process and the use thereof in food and liquid crystal applications as well as in optical, cosmetic and medical applications.

The terms used in the specification and claims have the meanings generally assigned to them in the field. As used in the present specification and claims, the following terms have the meanings defined below.

The term “cellulose material” refers to any cellulose raw material source. Almost any types of cellulose raw materials are suitable as a cellulose material for the method and process of the present invention, as described below. The cellulose material used in the invention can be obtained from wood-based or non-wood-based material. In the invention, it is possible to use cellulose material that comprises pulp, such as chemical pulp, mechanical pulp, thermomechanical pulp or chemithermomechanical pulp. The cellulose material can be based on any plant material containing cellulose. The plant material can be wood-based or non-wood-based. The wood can be of softwood, such as spruce, pine, fir, larch, Douglas spruce or hemlock, or of hardwood, such as birch, aspen, poplar, alder, eucalyptus or wattle, or it can be a mixture of soft- and hardwoods. The non-wooden material can be from agricultural remnants, grasses or other plant materials, such as straws, leaves, bark, seeds, peels, flowers, vegetables or fruits of cotton, corn, wheat, oat, rye, barley, rice, flax, hemp, abaca, sisal, jute, ramie, kenaf, bagasse, bamboo or cane. The cellulose material can be of cellophane. The cellulose can also originate from prochordata (Urochordata or Tunicata).

Cellulose “nanocrystals” (whiskers) are nano-sized rods of crystalline cellulose. Nano- and microcrystalline cellulose differ from each other in their particle size. Nanocrystals are single cellulose crystals: their width corresponds to the width of the native cellulose microfibril, about 3-10 nm (e.g. 7 nm in cotton cellulose) and their length the length of the crystalline area in the microfibril, about 50-2000 nm (e.g. between 5 nm and 300 nm in cotton cellulose) depending on the source of cellulose. The diameter of microcrystalline cellulose particles is several micrometers or tens of micrometres. In principle, cellulose microcrystals consist of nanocrystalline particles, i.e. microcrystals are aggregates of nanocrystals. Microcrystals are easier to manufacture than nanocrystals, since with microcrystals there is no need to control or prevent the aggregation that easily occurs.

In scientific literature cellulose nanocrystals are commonly referred to as cellulose nanocrystals, nanocrystalline cellulose, cellulose whiskers, cellulose nanowhiskers. In older publications, nanocrystalline cellulose has also been referred to as microcrystalline cellulose.

With regard to both micro- and nanocrystals, it is essential that the acid hydrolysis in the amorphous parts of the microfibril is completed. When all the amorphous parts have been hydrolyzed, the LODP (level off degree of polymerisation) point is reached.

After this, the acid hydrolysis decreases the degree of polymerization (DP) only marginally and very slowly. The preparation of nanocrystalline cellulose has an exact reaction window. In case of microcrystalline cellulose, there is no desire to achieve a stable dispersion. Microcrystalline cellulose must be filtered. Nanocrystalline cellulose requires dialysis.

Typically, nanocrystals are prepared by hydrolysis in about 64% by weight liquid sulphuric acid. The reaction is stopped with a 10-fold dilution, followed by centrifugation, dialysis, ion exchange and dispersion by ultrasound. The hydrolysis with H₂SO₄ is not an environmentally friendly process. The process requires a great amount of water and when washing reaction products, a great amount of waste water is formed. Use of high liquid acid concentrations also involves a recycling problem: since the acid must be washed out of the micro- and nanocrystals, it is substantially diluted and cannot be completely recovered. In addition, the process is quite laborious and precautionary measures are needed, because the sulphuric acid is quite caustic.

After the acid hydrolysis the surface of the nanocrystal can be charged or it can be to some extent neutral, depending on the hydrolizing acid. The acid hydrolysis with a sulphuric acid introduces negatively charged sulphate groups (SO₄⁻) onto the surface of the nanocrystals. After the acid hydrolysis with gaseous HCl or HNO₃, the surface of the nanocrystals is neutral and the nanocrystals tend to form aggregates. Without surface modification, the cellulose nanocrystals have a tendency to agglomerate. After refining, the neutral cellulose nanocrystals can be dispersed homogeneously in formic acid using vigorous ultrasonication.

Cellulose nanocrystals are mainly neutral, depending on the hydrolyzing acid to be used. The cellulose nanocrystals can be modified by esterifying, adding palmitate groups (performed with gaseous palmitoyl chloride) or acetylating with gaseous trifluoroacetic acid into hydrophobic.

Gaseous hydrochloric acid (HCl) causes the degree of polymerization to decrease at room temperature, which is required for the formation of micro- and nanocrystalline cellulose material. The decrease of the degree of polymerization can take place within a few hours, preferably in 30 minutes. Micro- and nanocrystals are obtained by mechanical breaking down following the hydrolysis, for example, by mechanical stirring and/or a following ultrasound treatment.

By using a gaseous acid it is possible to avoid several of the environmentally harmful micro- and nanocrystalline cellulose material manufacturing steps, which may also be difficult to apply on industrial scale. Large amounts of water are not needed for rinsing the sample, recycling of the acid is easier and the dialysis used for purification can be omitted. Therefore recycling of the material and its processability are improved.

On the surface of the cellulose fibre, there is a thin water layer, meaning that a high local acid concentration is formed when the gaseous acid adsorbs onto the fibre surface. Preferably the cellulose is dry, but not entirely dry. The moisture content of the cellulose is between 1% and 80%. Preferably, the moisture content of the cellulose is between 1% and 10%, more preferably between 2% and 9%, and even more preferably between 3% and 8%, between 4% and 7%, or between 5% and 6%. The absolute amount of water on the fibre surface is so small that the local H₃O⁺ concentration is high. This leads to a surprisingly high breakdown rate.

By the inventive process dry hydrolyzed surface-modified micro- and/or nanocrystalline cellulose substrate can be obtained, from which mono- and oligosaccharides, such as sugars, can be separated by using water, and the cellulose can be mechanically broken down.

One embodiment of the invention provides a process for preparing micro- and/or nanocrystalline cellulose material in the presence of an acid in the gas phase, the process comprising steps in which the cellulose material is hydrolyzed in the presence of at least one acid in the gas phase, the moisture content of the cellulose material being between 1% and 80%, the cellulose material is surface-modified, and the hydrolyzed cellulose material is mechanically treated in order to obtain micro- and/or nanocrystalline cellulose material.

The inventive process can comprise a step, in which water-soluble mono- and oligosaccharides can be separated from the hydrolyzed cellulose by extraction. Mono- and oligosaccharides can comprise, for example, glucose and its oligomers, arabinose, xylose, mannose and other disintegration products of hemicelluloses. Mono- and/or oligosaccharides, for example, sugars, can be separated from the hydrolyzed cellulose by extraction. The TOC of the sugars is determined, they are analyzed by HPLC and the amount of eventual residual acid is measured. The separated sugars can be further fermented into ethanol.

The surface modification of the cellulose material can be chemical or physical modification. The chemical modification can be based on, for example, acetylation, carboxymethylation, oxidation, esterification or etherification reactions of cellulose molecules. The modification can also be performed by a physical adsorption of anionic, cationic or non-ionic agents or any combination of thereof onto the surface of cellulose. The described modification can be performed before, after or during the acid hydrolysis of the cellulose material. The chemical modification can comprise, for example, a TEMPO oxidation, acetylation and/or carboxymethylation. The cellulose material can be comprised of labile chemically modified pulp or cellulose raw material.

TEMPO (2,2,6,6-tetramethylpiperidine-1-oxyl) is a chemical compound of formula (CH₂)₃(CME₂)₂NO. It is a stable radical, and it is used as a catalyst in oxidation of primary alcohols into aldehydes. In TEMPO oxidation, carboxyl groups are introduced onto the surface of a nanocrystal and thus it disperses homogeneously in water. N-oxyl-mediated oxidation, for example with 2,2,6,6-tetramethyl-1-piperidine-N-oxide (TEMPO), can lead to a very labile cellulose material.

Acid hydrolysis of the carboxymethylated pulp with gaseous HCl introduces charges onto the surface of the nanocrystal and thus it disperses in water. As the TEMPO-oxidated and carboxymethylated pulp is hydrolyzed in HCl vapour and thereafter dispersed in water or other solvents, many process steps can be avoided.

Mechanical treatment refers to mechanical breaking down, such as grinding, crushing, dispersing, ultrasound treatment or other breaking down, but not limited to these. The mechanical treatment can be performed by any known method of breaking down. The mechanical treatment can be performed by a suitable apparatus, such as a refiner, grinding machine, homogenizer, crusher, friction grinding machine, fluidizer, such as a microfluidizer, macrofluidizer or fluidizer-type homogenizer or an ultrasound sonicator.

The process according to the invention is preferably performed under atmospheric conditions, i.e. normal atmosphere and normal pressure. The process can be carried out at a temperature that is between 0° C. and 100° C., preferably the temperature is between 10° C. and 40° C., more preferably between 15° C. and 35° C., most preferably between 18° C. and 22° C. The temperature is, for example, room temperature.

According to the invention, the process uses at least one acid in the gas phase. The vapour pressure of the gas used in the invention is such that it gasifies at room temperature, so that the acid adsorbs onto the cellulose surface. For example, one of the following can be used as the acid: hydrochloric acid, nitric acid and/or trifluoroacetic acid. The concentration of the acid can be at least 1% by volume. Preferably, the concentration of the acid in the gas phase is between 2% and 99% by volume, for example, 15% by volume, 38% by volume, or 68% by volume.

The natural vapour pressure of the acid/water mixture, for example, a HCl/water mixture, which is sufficiently great to gasify the HCl into the vapour phase can be utilized in the inventive process, meaning that a separate reaction is not needed. As a result, HCl can also be transferred onto a cellulose substrate without separate mixing with air and without mechanical flow.

As hydrophobic groups have been introduced onto the surface of micro- and/or nanocrystals, the dispersion of nanocrystals in a hydrophobic solvent, such as toluene or chloroform, is possible.

In a preferred embodiment of the invention the cellulose material used as the starting material is modified and/or treated before hydrolysis. Moreover or alternatively, the hydrolyzed cellulose can be modified and/or treated after hydrolysis. Pre- and post-treatments can contribute to dispersion and/or enable the different applications of the nanocrystals. Examples of treatments before and after the hydrolysis include hydrofobization, TEMPO-mediated oxidation and carboxymethylation.

The hydrolyzed cellulose can be dispersed using suitable dispersion processes known in the art. Mechanical dispersion processes can also be used in the process of this invention. Examples of solvents, in which the cellulose material can be dispersed, include formic acid and ethyl acetate. The cellulose hydrolyzed with HCl can be dispersed in formic acid using vigorous ultrasonication after the cellulose nanocrystals are refined into powder. The cellulose material hydrolyzed with nitric acid can be dispersed in formic acid using vigorous ultrasonication after refining.

The HCl in the gas phase hydrolyzes the TEMPO-oxidated pulp into cellulose nanocrystals. This is due to the fact that the TEMPO oxidation adds carboxyl groups onto the surface of the nanocrystal and thus is disperses homogeneously in water or other solvents. The HCl in the gas phase hydrolyzes the carboxymethylated pulp into cellulose nanocrystals, producing a charge onto the surface of the nanocrystal and contributing to the dispersion in water or other solvents.

The inventive process can be carried out within a few hours, preferably, for example, in 30 minutes.

The viscosity of the hydrolyzed and broken-down cellulose is determined. Also the following analysis tools can be used in the inventive process: Cuen viscosity, gel permeation chromatography, and the CCOA method.

An object of the invention is also a product that contains micro- and/or nanocrystalline cellulose. The invention also relates to a cellulose product prepared by the said process and the use thereof in food and liquid crystal applications as well as in optical, cosmetic and medical applications. In addition, micro- and/or nanocrystalline cellulose can be used, for example, in the following applications: water-based varnishes in hardwood floorings, iridescent NCC films in security papers, architectonic applications and polymer reinforcements.

The following examples are presented to further illustrate the invention and are not to be construed as limiting on the scope of the invention. In the light of the specification, the person skilled in the art will be able to modify the invention in many different ways for preparing micro- and/or nanocrystalline cellulose material in the presence of an acid in the gas phase.

### EXAMPLES

### Example 1

Acid Hydrolysis of Cotton Cellulose

A filter paper sheet of cotton cellulose (type Whatman 1, solids content about 95%) was placed in an desiccator with a small amount of liquid hydrochloric acid (HCl) on the bottom. The test conditions comprised normal air pressure and room temperature. The acid used was 2.1%, 15%, 68%, and 99% HCl in the gas phase, corresponding to 20%, 25%, 30% and 37% liquid acid, respectively. Table 1 shows the concentrations of gaseous hydrochloric acid as compared to the corresponding liquid hydrochloric acid.

TABLE 1
The concentration of hydrochloric acid in liquid and gas
phase in normal air pressure and room temperature.

| Hydrochloric acid in liquid | Hydrochloric acid in gas phase |
|---|---|
| [% by weight] | [% by volume] |
| 20 | 2.1 |
| 25 | 15 |
| 27 | 38 |
| 30 | 68 |
| 37 | 99 |

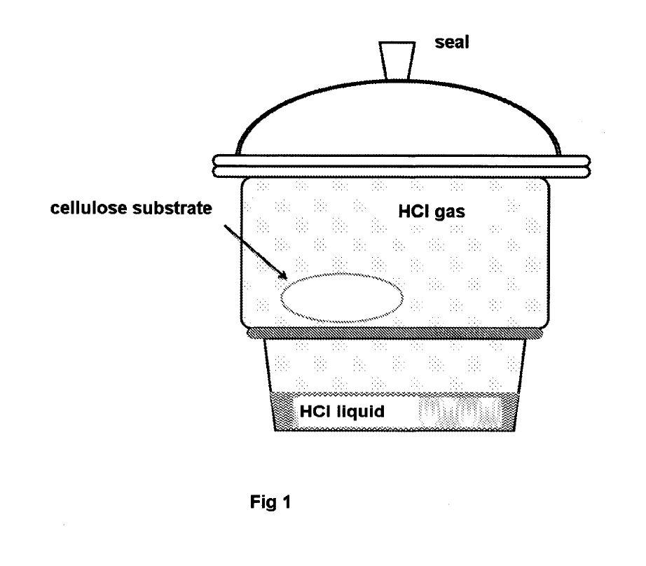

The experimental arrangement is shown in FIG. 1. The natural vapour pressure of liquid HCl was great enough to gasify the HCl into the gas phase at room temperature and transfer the HCl onto the cellulose substrate, which was cotton cellulose.

The results can be analyzed, for example, by the following methods:
Cuen viscosity: DPᵥ
gel permeation chromatography (GPC): DP_{w} and DPₙ,
CCOA method (carbazole-9-carboxylic acid [2-(2-amino-oxyethoxy)ethoxy]amide): the amount of carbonyl groups.

CCOA measurements indicated that no oxidation of cellulose occurred in the system during the hydrolysis of gaseous HCl.

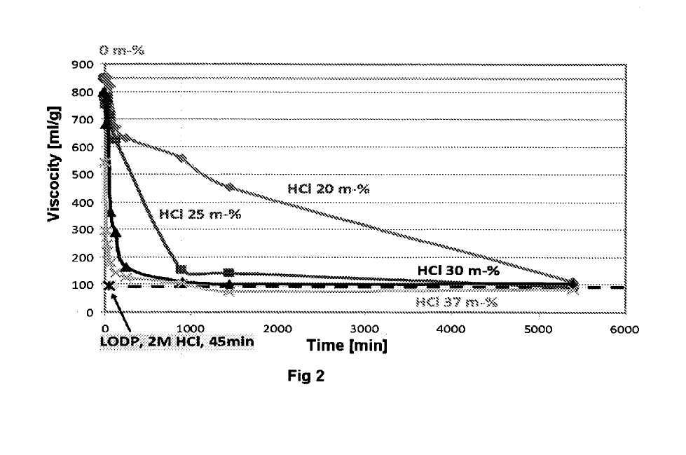

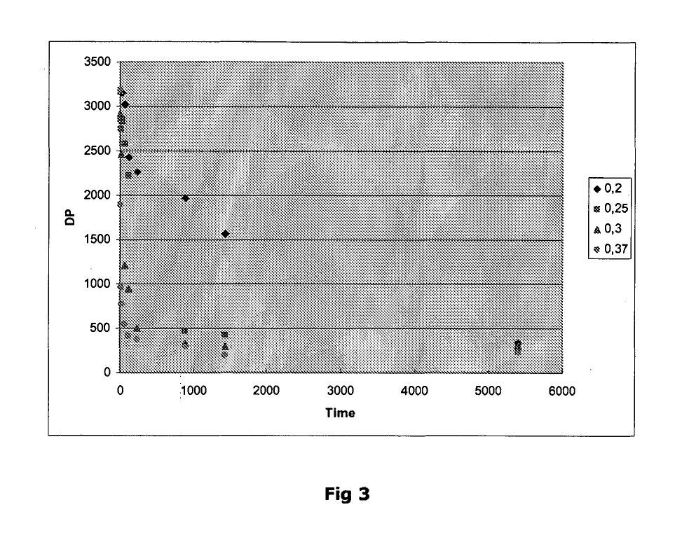

FIG. 2 shows the results of the acid hydrolysis when using 2.1%, 15%, 68%, and 99% gaseous hydrochloric acid, corresponding to 20%, 25%, 30%, and 37% liquid hydrochloric acid. When the concentration of the hydrochloric acid was increased at room temperature, the LODP point was reached more rapidly. Nanocrystalline cellulose was formed, when the LODP value exceeded 100.

Table 2 shows the hydrolysis time, viscosity and DPᵥ with different acid concentrations.

TABLE 2
Cellulose hydrolysis time, viscosity and DPᵥ with different
hydrochloric acid concentrations, 20%, 25%, 30%, and 37%.

| Sample | Time [min] | Viscosity | DPᵥ |
|---|---|---|---|
| 20% | 0 | 858 | 3170 |
| | 1 | 859 | 3174 |
| | 15 | 779 | 2848 |
| | 30 | 854 | 3154 |
| | 60 | 821 | 3019 |
| | 120 | 673 | 2420 |
| | 240 | 634 | 2265 |
| | 890 | 559 | 1969 |
| | 1440 | 455 | 1567 |
| | 5400 | 113 | 333 |
| 25% | 0 | 858 | 3170 |
| | 1 | 781 | 2856 |
| | 15 | 752 | 2738 |
| | 30 | 778 | 2843 |
| | 60 | 712 | 2577 |
| | 120 | 623 | 2221 |
| | 890 | 153 | 467 |
| | 1440 | 141 | 426 |
| | 5400 | 93 | 268 |
| 30% | 0 | 858 | 3170 |
| | 1 | 796 | 2917 |
| | 15 | 681 | 2452 |
| | 30 | 776 | 2835 |
| | 60 | 361 | 1212 |
| | 120 | 290 | 950 |
| | 240 | 163 | 501 |
| | 895 | 112 | 330 |
| | 1440 | 101 | 294 |
| | 5400 | 105 | 307 |
| 37% | 0 | 858 | 3170 |
| | 1 | 540 | 1895 |
| | 15 | 293 | 961 |
| | 30 | 242 | 777 |
| | 60 | 175 | 542 |
| | 120 | 138 | 416 |
| | 240 | 124 | 370 |
| | 895 | 101 | 294 |
| | 1440 | 70 | 196 |
| | 5400 | 81 | 230 |

TABLE 3
Cellulose hydrolysis time and degree of polymerization
(DP) with different hydrochloric acid concentrations,
20%, 25%, 30%, and 37%.

DP

| Time [min] | 20% | 25% | 30% | 37% |
|---|---|---|---|---|
| 0 | 3170 | 3170 | 3170 | 3170 |
| 1 | 3174 | 2856 | 2917 | 1895 |
| 15 | 2848 | 2738 | 2452 | 961 |
| 30 | 3154 | 2843 | 2835 | 777 |
| 60 | 3019 | 2577 | 1212 | 542 |
| 120 | 2420 | 2221 | 950 | 416 |
| 240 | 2265 | | 501 | 370 |
| 890 | 1969 | 467 | 330 | 294 |
| 1440 | 1567 | 426 | 294 | 196 |
| 5400 | 333 | 268 | 307 | 230 |

### Example 2

Acid Hydrolysis of Cellulose Nanocrystals in the Gas Phase with HCl and HNO₃

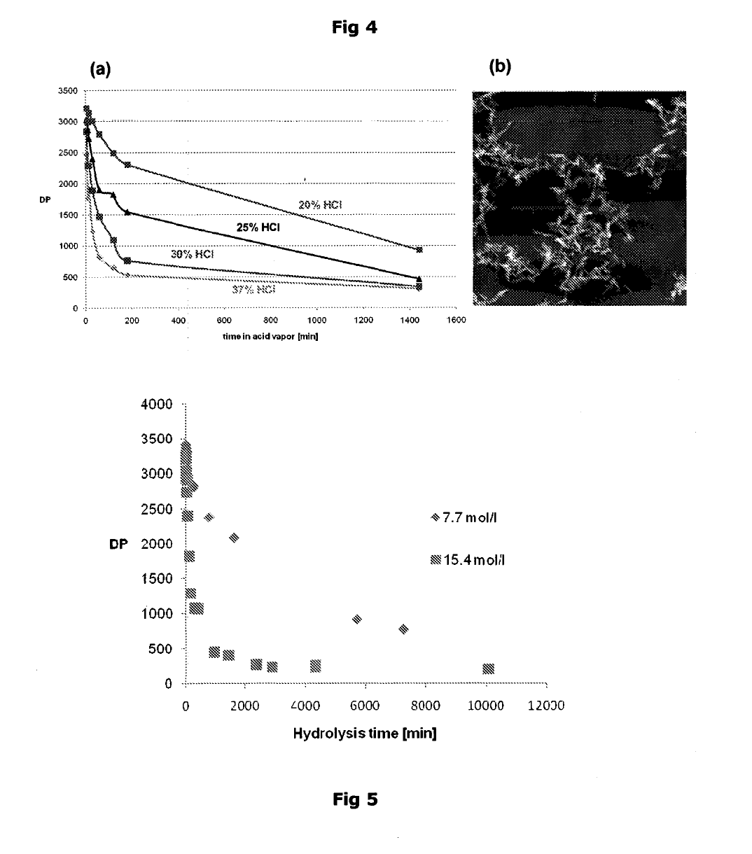

Hydrolyses were performed in a vacuum desiccator at a normal air pressure and room temperature. The liquid hydrochloric acid, HCl (35%) or nitric acid, HNO₃ (65%) was placed on the bottom of the desiccator and allowed to evaporate. The replacement of the excess air with acid/vapour mixture was enabled by opening and closing the desiccator valve repeatedly over 6-12 hours. The hydrolysis time needed to achieve nanocrystals with 35% HCl by weight was 3 hours. When 15.5 mol/l HNO₃ was used, nanocrystals were formed within 24 hours (FIGS. 4 and 5).

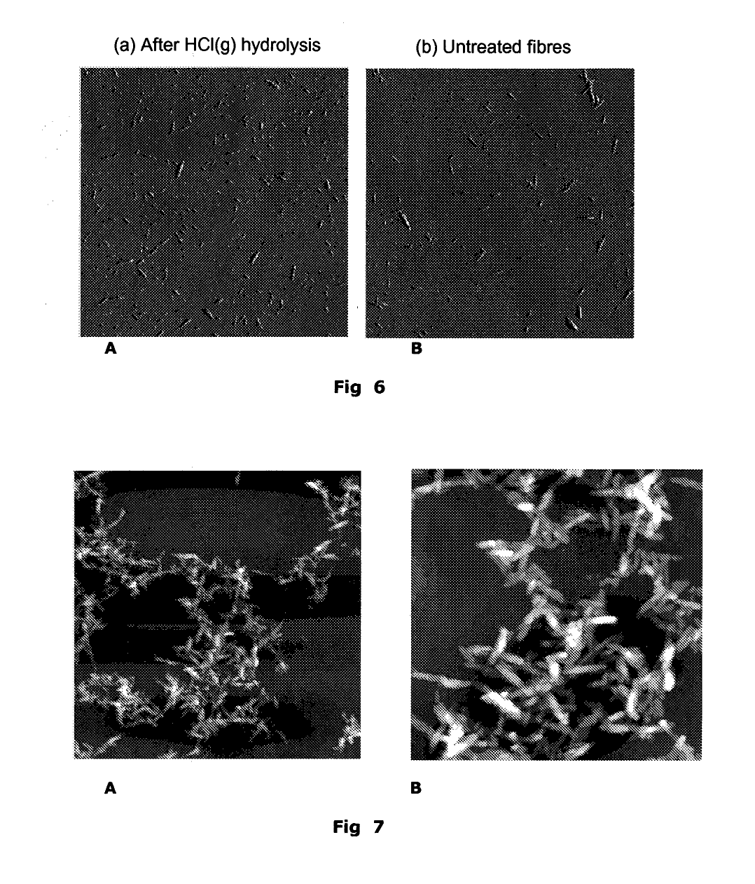

Adding of sulphate groups to the hydrolyzed filter paper was performed with 55% H₂SO₄ at 60° C. for 2 hours. In this way it was demonstrated that cellulose nanocrystals were obtained by a HCl acid hydrolysis and gaseous nitric acid. The atomic force microscopy (AMF) image of FIG. 6A shows that stable dispersions of nanocrystals can be obtained, when sulphate groups are added to the cellulose substrate hydrolyzed with gaseous HCl (35%, 3 h). In FIG. 6B is demonstrated that, when the pre-hydrolysis is not performed with an acid in the gas phase, nanocrystals are observed but fewer and, moreover, their sulphation is inadequate.

### Example 3

Dispersion of Nanocrystals Obtained by HCl and HNO₃ Hydrolysis in Formic Acid

The hydrolysis of cotton fibres was performed as in Example 2. After HCl(g) and HNO₃(g) hydrolysis, the filter paper was refined into powder in a Wiley mill.

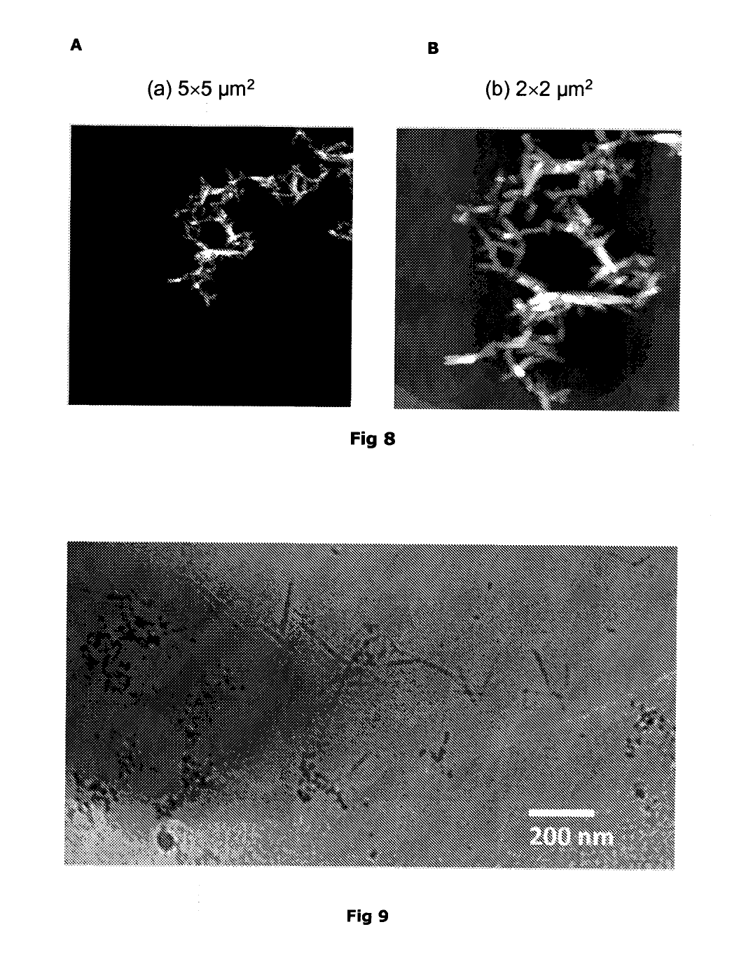

Thereafter, the powder was dispersed in 85% formic acid (1 g/l dispersion) by using ultrasonic bath (FIGS. 7 and 8). In formic acid were made to disperse nanocrystals prepared with acid vapour and having the same length (7 nm) as when prepared with liquid acid (FIG. 9).

### Example 4

Dispersion of Nanocrystals Obtained by HNO₃ Hydrolysis in Ethyl Acetate

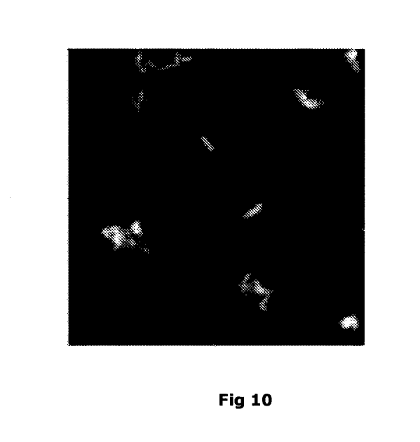

The hydrolysis of cotton fibres was performed as in Example 2. After HNO₃ hydrolysis, the filter paper was refined into powder in a Wiley mill. Thereafter, the powder was dispersed in ethyl acetate (1 g/l dispersion) by using ultrasonic bath (FIG. 10).

### Example 5

Acid Hydrolysis of a TEMPO Pulp

The hydrolysis of a TEMPO pulp was performed in a vacuum desiccator at a normal air pressure at room temperature. The liquid hydrochloric acid was placed on the bottom of the desiccator and allowed to evaporate. The replacement of the excess air with acid/vapour mixture was enabled by opening and closing the desiccator valve repeatedly over 6-12 hours. After the hydrolysis, the TEMPO pulp was broken down into nanocrystals, which disperse in water by ultrasound bath.

### Example 6

Hydrolysis of a Carboxymethylated Pulp

The hydrolysis of a carboxymethylated pulp was performed in a vacuum desiccator at a normal air pressure at room temperature. The liquid HCl was placed on the bottom of the desiccator and allowed to evaporate. The replacement of the excess air with acid/vapour mixture was enabled by opening and closing the desiccator valve repeatedly over 6-12 hours. After the hydrolysis, the carboxymethylated pulp was broken down into nanocrystals, which disperse in water by ultrasound bath.

### Example 7

Hydrofobization

The following treatments are performed after the hydrolysis, i.e. they are performed, as a LOPD value is achieved by an acid in the gas phase.

1. Esterifying of the surface in the gas phase

2. Adding of palmitate groups with palmitoyl chloride as reagent.

Adding of palmitate groups is performed with palmitoyl chloride as reagent. The reaction is carried out in an open container, in which the liquid palmitoyl chloride lies on the bottom and the hydrolyzed cellulose substrate is placed on a grate above the liquid. The container is placed in the vacuum oven and the reaction is allowed to occur at 160-190° C. at 100 millibar pressure for 2-6 hours.

3. Acetylation with gaseous trifluoroacetic anhydride

Due to the high vapour pressure of trifluoroacetic anhydride (TFAA), the reaction can be performed at room temperature in negative pressure, provided that e.g. a vacuum pump is attached to the vacuum desiccator. A reaction time of 24 hours is adequate in order to modify the surface of any cellulose substrate.

It is obvious for a person skilled in the art that as the technique advances, the basic principle of the invention may be implemented in several different ways. The invention and its embodiments are therefore not restricted to the above-described example but they may vary within the scope of the claims.

1. A process for preparing micro- and/or nanocrystalline cellulose material in the presence of an acid in the gas phase, characterized in that the process comprises steps, in which the cellulose material is hydrolyzed in the presence of at least one acid in the gas phase, the moisture content of the cellulose material being between 1% and 80%, the cellulose material is surface-modified, and the hydrolyzed cellulose material is mechanically treated in order to obtain micro- and/or nanocrystalline cellulose material.

2. The process according to claim 1, characterized in that the process further comprises a step in which water-soluble mono- and oligosaccharides are separated from the hydrolyzed cellulose material.

3. The process according to claim 1, characterized in that the surface modification is a chemical modification.

4. The process according to claim 3, characterized in that the chemical modification comprises TEMPO oxidation, acetylation and/or carboxymethylation.

5. The process according to claim 1, characterized in that the cellulose material is modified before the hydrolysis.

6. The process according to claim 1, characterized in that the cellulose material is modified after the hydrolysis.

7. The process according to claim 1, characterized in that the vapour pressure of the acid used is such that the acid gasifies into the gas phase at room temperature and adsorbs onto the surface of the cellulose material.

8. The process according to claim 1, characterized in that one of the following is used as the acid: hydrochloric acid, nitric acid and/or trifluoroacetic acid.

9. The process according to claim 1, characterized in that the concentration of the acid in the gas phase is at least 1% by volume.

10. The process according to claim 1, characterized in that the hydrolyzed cellulose material is mechanically broken down.

11. The process according to claim 1, characterized in that the mechanical breaking down comprises mechanical stirring and/or ultrasound treatment.

12. The process according to claim 1, characterized in that the process is carried out at normal air pressure.

13. The process according to claim 1, characterized in that the process is carried out at a temperature between 0° C. and 100° C., preferably between 10° C. and 40° C., more preferably between 15° C. and 35° C., more preferably between 18° C. and 22° C., most preferably at room temperature.

14. A product containing micro- and/or nanocrystalline cellulose material, characterized in that the product has been prepared by a process according to claim 1.

15. The use of the product according to claim 14 as a reinforcement or a filler.

16. The use of the product according to claim 14 in optical and liquid crystal applications.

17. The use of the product according to claim 14 in food, cosmetic or medical applications.
